(19) United States
(12) Patent Application Publication
(10) Pub. No.: US 2025/0163975 A1
(43) Pub. Date: May 22, 2025

(54) SLIDING SLEEVE

(71) Applicant: Miba Sinter Austria GmbH, Vorchdorf (AT)

(72) Inventors: Martin OHLER, Vorchdorf (AT); Horst RÖSSLER, Krenglbach (AT); David JOCHER, Ebensee (AT)

(73) Assignee: Miba Sinter Austria GmbH, Vorchdorf (AT)

(21) Appl. No.: 18/944,106

(22) Filed: Nov. 12, 2024

(30) Foreign Application Priority Data
Nov. 21, 2023 (AT) A50943/2023

(51) Int. Cl. F16D 23/02; F16D 11/14

(52) U.S. Cl. CPC F16D 23/025; F16D 11/14

(57) ABSTRACT

A sliding sleeve for a synchronization device includes an annular sleeve body having first and second end faces and, on an inner lateral surface, an internal toothing with teeth, which have wedge-shaped roof slopes at distal end regions, and with at least one axial stop which serves for limiting the displaceability of the sliding sleeve, and which is formed between the internal toothing teeth. The axial stop is formed in a block tooth which has a width in the circumferential direction greater than a width of the teeth of the internal toothing, and which has at least one recess extending in the axial direction, which, starting at the first end face, extends in the direction of the second end face of the sleeve body, and which is at least as wide in the circumferential direction as a width of the tooth gaps between the teeth of the internal toothing.

### CROSS REFERENCE TO RELATED APPLICATIONS

Applicant claims priority under 35 U.S.C. § 119 of Austrian Application No. A50943/2023 filed Nov. 21, 2023, the disclosure of which is incorporated by reference.

### BACKGROUND OF THE INVENTION

### 1. Field of the Invention

The invention relates to a sliding sleeve for a synchronization device comprising an annular sleeve body which has a first and a second end face, and which, on an inner lateral surface, has an internal toothing with teeth, which have wedge-shaped roof slopes at distal end regions, and with at least one axial stop by means of which the axial displaceability of the sliding sleeve is limited, wherein the axial stop is formed between the teeth of the internal toothing.

The invention further relates to a synchronization device with a first receptacle for a first drive element and a second receptacle for a second drive element which can be separated from the first drive element, with an axially displaceable sliding sleeve which has an internal toothing, with a synchronization hub which has an external toothing and is arranged below the sliding sleeve in the radial direction, and with a coupling body which has an external toothing, wherein the internal toothing of the sliding sleeve engages in the external toothing of the synchronizing hub and is arranged so as to be engageable in the external toothing of the coupling body by axial displacement, and with at least one axial stop with which the axial displaceability of the sliding sleeve is limited and which is integrated in the internal toothing of the sliding sleeve.

The invention also relates to an E-axle for a motor vehicle with a synchronization device.

### 2. Description of the Related Art

In order to limit the shift path of a synchronization device, such as in particular a locking synchronization, it is known to provide mechanical stops for the sliding sleeve (also referred to as a clutch sleeve). The shift path in synchronizations is defined by the axial travel path of the sliding sleeve from the neutral position to an end stop at which the sliding sleeve fully engages with the teeth of the coupling body for power transmission.

In addition to axial stops in the form of a circumferential collar on the coupling body, sliding sleeves with an axial stop have also been described in the prior art. For example, AT 519 200 A1 describes a claw coupling device with a first receptacle for a first drive element and a second receptacle for a second drive element which can be separated from the first drive element, with an axially displaceable sliding sleeve which has an internal toothing, with a synchronization hub which has an external toothing and is arranged below the sliding sleeve in the radial direction, and with a coupling body which has an external toothing, wherein the internal toothing of the sliding sleeve engages in the external toothing of the synchronizing hub and is arranged so as to be engageable in the external toothing of the coupling body by axial displacement, and with at least one axial stop with which the axial displaceability of the sliding sleeve is limited and which is integrated in the internal toothing of the sliding sleeve.

DE 10 2014 208 031 A1 describes a sliding sleeve for synchronizing a gear wheel with a shaft, wherein the sliding sleeve has a coupling toothing for an engagement in a mating toothing that can be produced by an axial movement of the sliding sleeve. The axial movement is limited by means of a stop element fixed to the sliding sleeve and the stop element is provided for interaction with the mating toothing. The stop element can be formed on the internal toothing of the sliding sleeve.

DE 10 2012 223 761 A1 discloses a sliding sleeve of a gear change gearbox of a motor vehicle, which has an internal toothing which has engagement teeth for engagement in mating toothings and stop teeth as two different types of teeth, wherein axial stops are arranged on the stop teeth and a part of the stop teeth have grooves. The stop teeth can be wider or narrower or shorter than the engagement teeth.

DE 10 2007 030 507 A1 describes a sliding sleeve for shifting gear steps of a manual transmission with at least one gear wheel, the clutch toothing of which has clutch teeth, wherein the sliding sleeve is displaceable from a neutral position in the direction of the gear wheel and has teeth with tooth heads for engaging with the clutch teeth and one or more stops for limiting the axial displaceability, wherein the stops are arranged on the tooth heads and form stop teeth.

### SUMMARY OF THE INVENTION

The present invention is based on the object of providing a simple-to-manufacture axial stop for a synchronization device and thus a space-saving embodiment of a synchronization device, in particular in an E-axle.

The object of the invention is achieved in the initially mentioned sliding sleeve in that the axial stop is formed in a block tooth which has a width in the circumferential direction which is greater than a width of the teeth of the internal toothing, and which has at least one recess in the axial direction which, starting at the first end face, extends in the direction of the second end face of the sleeve body, and which is at least as wide in the circumferential direction as a width of the tooth gaps between the teeth of the internal toothing.

Furthermore, the object is achieved by the initially mentioned synchronization device which comprises the sliding sleeve according to the invention, or by the initially mentioned E-axle which comprises the synchronization device according to the invention.

In this regard, the advantage is that by the at least one recess a block tooth is provided, which is configured to receive the teeth of the toothing of the coupling body. Thus, the block tooth not only fulfills the function of the axial stop, but as part of the internal toothing, it also fulfills the function of the internal toothing at the same time. In contrast to the prior art, the invention makes it possible to fully form the internal toothing. The invention makes it possible to provide a compact, axially short synchronization device, which in particular simplifies the installation in an E-axle.

According to one embodiment variant of the invention, it may be provided that the block tooth has multiple recesses in the axial direction, wherein a tooth is formed between each of the recesses which tooth, with the exception of the axial length, is formed in the same way as a tooth of the internal toothing. It is thus possible to make the block tooth wider in the circumferential direction, whereby the block tooth can contribute to an improvement in the strength of the sliding sleeve itself, so that the sliding sleeve can also optionally be made shorter in the axial direction. In addition, the mechanical load on the block tooth during the synchronization of the different rotational speeds can hence be distributed over a larger contact surface of the block tooth with the teeth of the coupling body.

According to a further embodiment variant of the invention, it can be provided that the block tooth has a radial indentation which is formed at a distance from the recess. This means that the block tooth can also be used for receiving and/or contacting a pressure piece of the synchronization device, as are known per se from the prior art.

According to another embodiment variant of the invention, it is possible for the recess to have an end surface in the axial direction, wherein the end surface is formed with wedge surfaces running inversely to the roof slopes, whereby the teeth of the coupling body have a larger contact surface on the axial stop and tooth breakages at the axial ends of the toothing of the coupling body can thus be better prevented.

According to another embodiment variant of the invention, it can also be provided that multiple block teeth are arranged distributed over the circumference of the internal toothing with at least one of the recesses, whereby the force flow during the clutch process can be equalized. In particular, this allows the impact load and the axial force during shifting to be better distributed over the entire circumference of the coupling body. In addition, this can also improve the sintering manufacturability of the sliding sleeve by making it possible to apply pressure more uniformly when pressing the powder or during calibration.

Preferably, according to an embodiment variant of the invention, all block teeth are formed equally, whereby the aforementioned effects can be provided distributed over the circumference of the sliding sleeve.

A simpler production of the block tooth can be achieved if the sliding sleeve is configured as a sintered component.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows an E-axle;

FIG. 2 shows a cutout from a synchronization device;

FIG. 3 shows a front view of a sliding sleeve;

FIG. 4 shows a detail of the sliding sleeve device according to FIG. 3; and

FIG. 5 shows an embodiment variant of a block tooth.

### DETAILED DESCRIPTION OF PREFERRED EMBODIMENTS

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

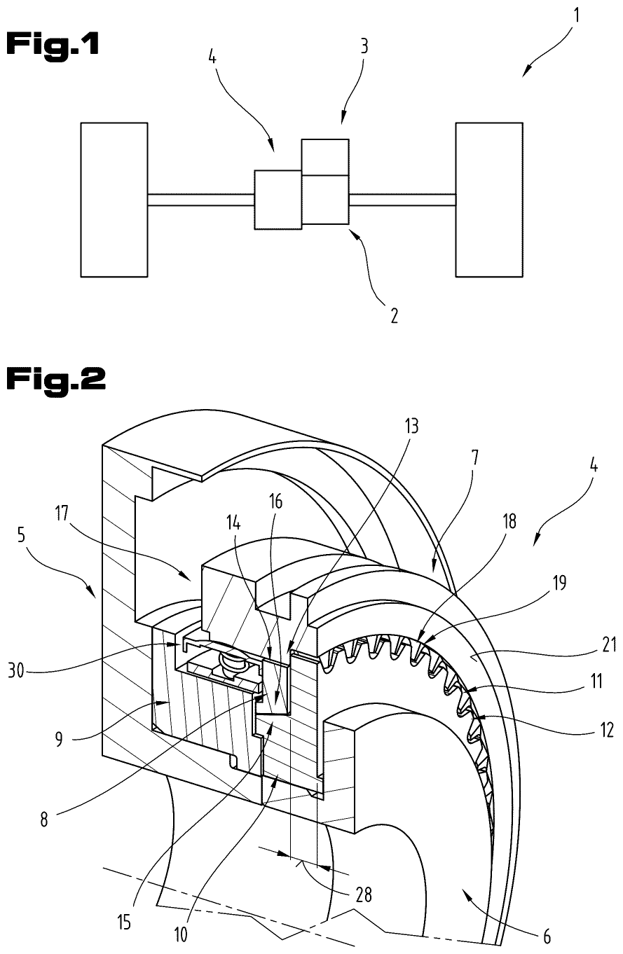

FIG. 1 shows a so-called E-axle 1 of an electric vehicle in a simplified and exemplary manner. In addition to an electric motor 2 and the power electronics module 3, the E-axle 1 also comprises a synchronization device 4.

Although the E-axle 1 is the preferred application of the synchronization device 4, the synchronization device 4 can also be used in applications in which a locking synchronization is used.

In FIG. 2, a cutout from an embodiment variant of the synchronization device 4 is shown in an oblique view. The synchronization device 4 comprises a first receiving element 5 for a first drive element not shown, such as a first shaft or a first axle, and a second receiving element 6 for a second drive element that can be separated from the first drive element, such as a second shaft or a second axle. Furthermore, the synchronization device 4 comprises an annular sliding sleeve 7, a synchronization ring 8, an annular synchronization hub 9, and an annular coupling body 10.

The coupling body 10 is non-rotatably connected to the second receiving element 6 and/or is formed in one piece with it and has an external toothing 11. The external toothing 11 is configured as a spur toothing with teeth 12.

The synchronization hub 9 also has external toothing, but this is not shown in FIG. 2. The external toothing of the synchronization hub 9 is also configured as a spur toothing with teeth. The synchronization hub 9 is arranged on the first receiving element 5 in a rotationally fixed manner and/or is formed in one piece with it. The synchronization hub is arranged below the sliding sleeve 7 in the radial direction.

The synchronization ring 8 is arranged on the coupling body 10. The synchronization ring 8 preferably has an external toothing 13 with teeth 14. The external toothing 13 is configured as a spur toothing.

The external toothing 11 of the coupling body 9 and the external toothing of the synchronization hub 8 as well as the external toothing 13 of the synchronization ring 8 are formed at the same radial height.

Preferably, the synchronization ring 8 has a conical surface 15 on the radially inner surface, which bears against a corresponding conical surface 16 of the coupling body 10. It may also be provided that a friction ring or a friction package with multiple friction rings is arranged between the two conical surfaces 15, 16, which has/have conical friction surfaces (possibly made of a friction material and/or a friction lining) on the outer and inner lateral surface.

The sliding sleeve 7 has a sleeve body 17. The sleeve body 17 has an internal toothing 18 with teeth 19 on a radially inner lateral surface. The internal toothing 18 is configured as a spur toothing. The internal toothing 18 is in constant engagement with the external toothing of the synchronization hub 9.

The sliding sleeve 7 is arranged so as to be axially displaceable in the synchronization device 4, so that it can be axially displaced from a first position, in which the two drive elements are not coupled to each other, into a second position, in which torque transmission between the two drive elements is enabled. FIG. 2 shows the second position of the sliding sleeve 7. Accordingly, the external toothing 11, 12 of the coupling body 10 and the synchronization ring 8 and the external toothing of the synchronization hub 9 as well as the internal toothing 18 of the sliding sleeve 7 are matched to each other in such a way that the internal toothing 18 of the sliding sleeve 7 can mesh with the external toothing of the synchronization hub 9 and, in the second position, also with the external toothing 11, 12 of the coupling body 10 and the synchronization ring 8.

The synchronization device 4 is configured as a one-sided locking synchronization device. The sliding sleeve 7 can therefore not be pushed onto another coupling body, as is known from change-speed gearboxes. The force fit between the sliding sleeve 7 and the coupling body 10 only occurs when the two drive elements mentioned above are synchronized. Before this, the synchronization ring 8 prevents the force fit.

The synchronization device 4 can also be configured without the synchronization ring 8.

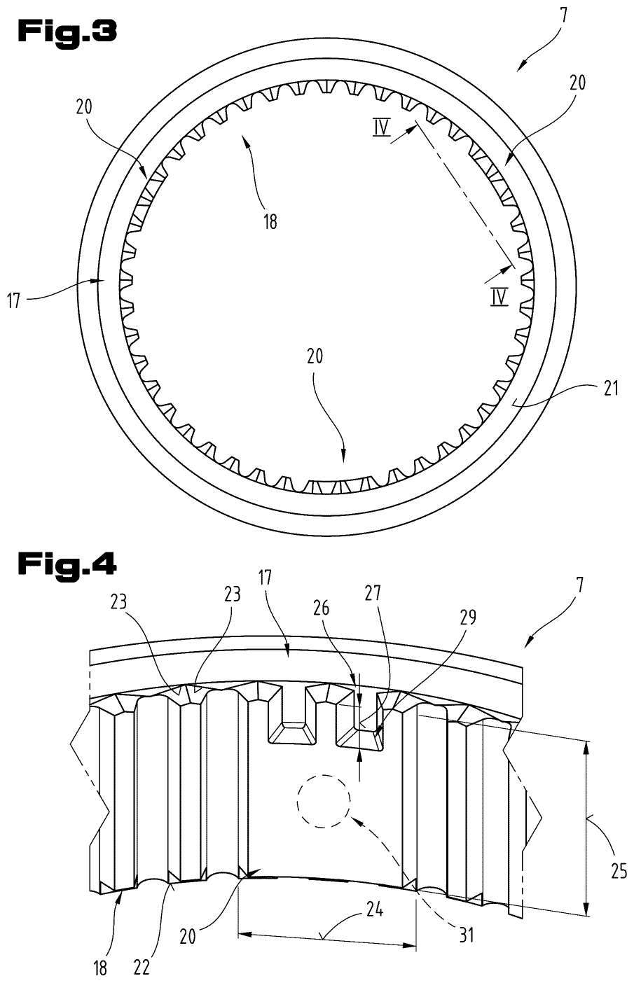

An embodiment variant of the sliding sleeve 7 is shown in FIGS. 3 and 4.

The sliding sleeve 7 has a block tooth 20. The block tooth 20 is integrated into the internal toothing 18. It does not project radially inwards beyond the internal toothing 18. The block tooth 20 forms an axial stop for the sliding sleeve 7, so that the sliding sleeve 7 can only be displaced in the axial direction until the coupling body 10 comes into contact with the axial stop. This prevents the sliding sleeve 7 from “overshooting” (i.e. moving too far) in the axial direction.

The block tooth 20 extends in the axial direction between a first end face 21 and a second end face 22 of the sleeve body 17, as do the teeth 19 of the internal toothing 18.

As can be seen from FIG. 4, the teeth 19 of the internal toothing 18 of the sliding sleeve 7 have wedge-shaped roof slopes 23 in a distal end region. Similarly, the teeth 12 of the coupling body 10 and the teeth 14 of the synchronization ring 8 have such wedge-shaped roof slopes at the distal end of the teeth 12, 14, which face the roof slopes 23 of the teeth 19 of the internal toothing 18 of the sliding sleeve 7. Such embodiments of toothing of locking synchronization devices are known, so that further statements in this regard are dispensed with. The roof slopes slide against each other when the sliding sleeve 7 is moved from the first to the second position, as is also known.

The block tooth 20 has a greater width 24 in the circumferential direction of the sliding sleeve 7 than the remaining teeth 19 of the internal toothing 18. For this purpose, the width 24 of the block tooth 20 and the width of the remaining teeth 19 are each measured at the same radial height in a region between the tooth root circle and half the height of the internal toothing 18 in the radial direction. The width 24 of the block tooth 20 is dimensioned such that the block tooth 20 has a width 24 of at least twice the width of a tooth 19 of the internal toothing 18 of the sliding sleeve 7 plus the width of the tooth gap between two teeth 19 of the internal toothing 18 of the sliding sleeve 7. The block tooth 20 thus extends in the circumferential direction of the sliding sleeve 7 over a toothing section comprising at least two teeth 19 of the internal toothing 18 of the sliding sleeve 7. In other words, at least two regular teeth 19 of the internal toothing 18 of the sliding sleeve 7 are replaced by the block tooth.

An axial length of the block tooth 20 can be selected from a range between 70% and 100% of the axial length of the remaining teeth 19 of the internal toothing 18 of the sliding sleeve 7. Preferably, the length 25 of the block tooth 20 is the same as the length of the remaining teeth 19 of the internal toothing 18 of the sliding sleeve 7.

The radial height of the block tooth 20 is preferably the same as the radial height of the teeth 19 of the internal toothing 18 of the sliding sleeve 7. However, the block tooth 20 can also have a radial height that is at most 10% smaller than the radial height of the teeth 19 of the internal toothing 18 of the sliding sleeve 7.

As can be seen from FIG. 4, the block tooth 20 has at least one recess 26 in the axial direction. The recess 26 begins at the tooth head of the block tooth 20 and extends in the radial direction at least over the entire radial height of the block tooth 20. It can also be formed to be deeper and extend into the sleeve body 17, although this is not preferred.

Furthermore, the recess 26 extends starting at the first end face 21 and extends in the direction of the second end face 22 of the sleeve body 17. An axial length 27 of the recess 26 can have between 80% and 120%, in particular 100%, of an axial length 28 (see FIG. 2) of the teeth 12 of the external toothing 11 of the coupling body 10 plus an axial length of the teeth 14 of the synchronization ring.

Furthermore, the recess 26 is at least as wide in the circumferential direction as a width of the tooth gaps between the teeth 19 of the internal toothing 18 of the sliding sleeve 7. Thus and due to the axial length 27 of the recess 26, it is made possible for the recess 26 in the block tooth 20 in the second (i.e. coupled) position to receive a tooth 12 of the external toothing 11 of the coupling body 10 and a tooth 14 of the external toothing 13 of the synchronization ring 8 (one behind the other in the axial direction). An end surface 29 of the recess 26 (viewed in the axial direction) thus forms the axial stop for the sliding sleeve 7, since in the maximum axial displacement of the sliding sleeve, the received tooth 14 of the external toothing 13 of the synchronization ring 8 is in contact with this end surface 29.

In a non-preferred embodiment variant of the synchronization device 4, the synchronization ring 8 is free of blocking surfaces, i.e. it does not have any roof slopes.

Thus, in the second (i.e. coupled) position, the recess 26 in the block tooth 20 receives only one tooth 12 of the external toothing 11 of the coupling body 10. The end surface 29 of the recess 26 (viewed in the axial direction) thus forms the axial stop for the sliding sleeve 7, since in the maximum axial displacement of the sliding sleeve, the received tooth 12 of the external toothing 13 of the coupling body 10 is in contact with this end surface 29.

According to a further embodiment variant of the synchronization device 4, it may be provided that the synchronization ring 8 has the external toothing 13 with the teeth 14 and the roof slopes, but this external toothing 13 is interrupted (recessed) in the area of the block tooth 20, i.e. has a gap which has a width in the circumferential direction which is at least as large as the width 24 of the block tooth 20 in the circumferential direction. Essentially, this recess can be produced by omitting a section comprising two teeth 14 (with a tooth gap between them) of the external toothing 13 of the synchronization ring 8.

In this embodiment variant, the recess is also preferably formed in the same way as in the embodiment variant with the synchronization ring 8 and external toothing 13, so that the tooth 12 of the external toothing 13 of the coupling body 10 is in contact with the end surface 29 as an axial stop of the sliding sleeve 7.

According to a preferred embodiment variant, the block tooth 20 has multiple recesses 26 in the axial direction. In particular, the block tooth 20 has two (as shown in FIG. 4) or three or four recesses 26. For each additional recess 26, the width 24 of the block tooth 20 in the circumferential direction of the sliding sleeve 7 increases by at least the sum of the width of a tooth 19 of the internal toothing 18 and the width of a tooth gap between two teeth 19 of the internal toothing 18 of the sliding sleeve 7. In particular, therefore, three, four or five regular teeth 19 of the internal toothing 18 are replaced by the block tooth 20.

The multiple recesses 26 are preferably all of the same geometric design.

A tooth is preferably formed between each of the multiple recesses 26 which tooth, with the exception of the axial length, is formed in the same way as a tooth 19 of the internal toothing 18 of the sliding sleeve 7. The block tooth 20 continues to form the internal toothing 18 of the sliding sleeve 7 even in case of multiple recesses 26, so that this internal toothing 18 is fully formed on the first end face 21 of the end face.

For the embodiments with the multiple recesses 26, the above explanations apply to the three embodiment variants with the reception of a tooth 14 of the external toothing 13 of the synchronization ring 8 and a tooth 12 of the external toothing 11 of the coupling body 10, or the reception of a tooth 12 of the external toothing 11 of the coupling body 10 and the synchronization ring 8 without external toothing 13, or the reception of a tooth 12 of the external toothing 11 of the coupling body 12 and the synchronization ring 8 with the external toothing 13 recessed in the area of the block tooth 20, correspondingly for all recesses 26 in the block tooth 20. However, mixed variants of these three embodiment variants are also possible, so that, for example, one of the multiple recesses 26 only receives one tooth 12 of the external toothing 11 of the coupling body 10 and another recess 26 of the block tooth 20 receives both a tooth 12 of the external toothing 11 of the coupling body 10 and a tooth 14 of the external toothing 13 of the synchronization ring 8.

As can be seen from FIG. 2, according to a further embodiment variant, it can be provided that the synchronization device 4 has at least one spring-loaded pressure piece 30, as is known per se from synchronization devices from the prior art. For further details of such pressure pieces 30, reference is thus made to the relevant prior art. With regard to the sliding sleeve 7 described here, it may be provided in this regard that the block tooth 20 has a radial indentation 31 which is formed at a distance from the recess 26. The indentation 31 can, for example, be provided to partially receive a spring-loaded ball of the pressure piece 30. A centering function, for example, can be enabled via this ball and the indentation 31.

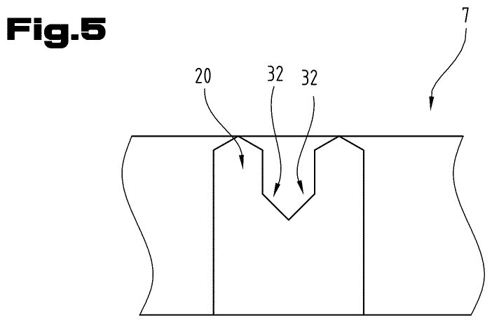

According to another embodiment variant of the sliding sleeve 7, it may be provided that end surface 29 of the recess(es) 26 is/are formed with wedge surfaces 32 running inversely to the roof slopes 23, as shown in FIG. 5. It is thus possible for the roof slopes 23 to be in contact with the wedge surfaces 32 over the entire surface (or over a larger surface).

Although the arrangement and/or formation of only one block tooth 20 in the internal toothing 18 of the sliding sleeve 7 is possible, according to a preferred embodiment variant the internal toothing 18 of the sliding sleeve 7 has multiple axial stops in the form of block teeth 20, which in particular can all be of the same design, preferably in the form of the block tooth 20 described. For example, between two and eight, in particular three (see FIG. 3) or four, such block teeth 20 can be arranged. Preferably, the multiple block teeth 20 are arranged and/or formed symmetrically distributed over the circumference of the internal toothing 18, for example offset by 120° in the case of three or offset by 90° in the case of four block teeth 20. In each case, the angle refers to the center axis of the block teeth 20 running in the axial direction.

The sliding sleeve 7 is preferably made of a sintered material, i.e. produced according to a sintering method (powder metallurgical process). Since sintering methods are known from the prior art, this process is not described here.

Alternatively, the sliding sleeve 7 can also be produced using an additive process (3D printing).

The internal toothing 18 of the sliding sleeve 7 preferably extends over the entire axial width of the sliding sleeve 7. It can also extend over only a partial section of this width.

The exemplary embodiments show possible embodiment variants of the sliding sleeve 7 and/or the synchronization device 4, while it should be noted at this point that various combinations of the individual embodiment variants are also possible.

Finally, as a matter of form, it should be noted that for ease of understanding of the structure of the sliding sleeve 7 and/or the synchronization device 4, these are not obligatorily depicted to scale.

Although only a few embodiments of the present invention have been shown and described, it is to be understood that many changes and modifications may be made thereunto without departing from the spirit and scope of the invention.

### LIST OF REFERENCE NUMBERS

1 E-axle
2 Electric motor
3 Power electronics module
4 Synchronization device
5 Receiving element
6 Receiving element
7 Sliding sleeve
8 Synchronization ring
9 Synchronization hub
10 Coupling body
11 External toothing
12 Tooth
13 External toothing
14 Tooth
15 Conical surface
16 Conical surface
17 Sleeve body
18 Internal toothing
19 Tooth
20 Block tooth
21 End face
22 End face
23 Roof slope
24 Width
25 Length
26 Recess
27 Length
28 Length
29 End surface
30 Pressure piece
31 Indentation
32 Wedge surface

What is claimed is:

1. A sliding sleeve (7) for a synchronization device (4) comprising an annular sleeve body (17), which has a first and a second end face (21, 22) and which on an inner lateral surface has an internal toothing (18) with teeth (19), which have wedge-shaped roof slopes (23) at distal end regions, and with at least one axial stop, by which the axial displaceability of the sliding sleeve (7) is limited, wherein the axial stop is formed between the teeth (19) of the internal toothing (18), wherein the axial stop is formed in a block tooth (20), which has a width (24) in the circumferential direction which is greater than a width of the teeth (19) of the internal toothing (17), and which has at least one recess (26) extending in the axial direction, which recess (26), starting at the first end face (21), extends in the direction of the second end face (22) of the sleeve body (17), and which is at least as wide in the circumferential direction as a width of the tooth gaps between the teeth (19) of the internal toothing (18).

2. The sliding sleeve (7) according to claim 1, wherein the block tooth (20) has multiple recesses (26) arranged next to one another in the axial direction, wherein a tooth is formed between each of the recesses (26), which tooth, with the exception of the axial length, is formed in the same way as a tooth (19) of the internal toothing (18).

3. The sliding sleeve (7) according to claim 1, wherein the block tooth (20) has a radial indentation (31) which is formed at a distance from the recess (26).

4. The sliding sleeve (7) according to claim 1, wherein the recess (26) has an end surface (29) in the axial direction, wherein the end surface (29) is formed with wedge surfaces (32) running inversely to the roof slopes (23).

5. The sliding sleeve (7) according to claim 1, wherein multiple block teeth (20) are arranged distributed over the circumference of the internal toothing (18), each of the block teeth (20) having at least one of the recesses (26).

6. The sliding sleeve (7) according to claim 5, wherein all block teeth (20) are formed in the same way.

7. The sliding sleeve (7) according to claim 1, wherein the sliding sleeve (7) is formed as a sintered component.

8. A synchronization device (4) having a first receiving element (5) for a first drive element and a second receiving element (6) for a second drive element which can be separated from the first drive element, having an axially displaceable sliding sleeve (7) which has an internal toothing (18), having a synchronization hub (9) which has an external toothing and is arranged below the sliding sleeve (7) in the radial direction, and having a coupling body (10) which has an external toothing (11), wherein the internal toothing (18) of the sliding sleeve (7) engages in the external toothing (11) of the synchronization hub (9) and is arranged so as to be engageable in the external toothing (11) of the coupling body (10) by axial displacement, and having at least one axial stop with which the axial displaceability of the sliding sleeve (7) is limited and which is integrated into the internal toothing (18) of the sliding sleeve (7), wherein the sliding sleeve (7) is configured according to claim 1.

9. An E-axle (1) for a motor vehicle with a synchronization device (4), wherein the synchronization device (4) is configured according to claim 8.
